(19) United States
(12) Patent Application Publication
(10) Pub. No.: US 2022/0051348 A1
(43) Pub. Date: Feb. 17, 2022

(54) SYSTEMS, METHODS AND COMPUTER PROGRAM PRODUCTS FOR CONNECTING DRIVERS IN A GIVEN RANGE

(71) Applicant: U-Tag-A-Long LLC, Columbia, SC (US)

(72) Inventor: Angela U. Spearman, Columbia, SC (US)

(21) Appl. No.: 17/403,691

(22) Filed: Aug. 16, 2021

Related U.S. Application Data
(60) Provisional application No. 63/066,063, filed on Aug. 14, 2020.

(51) Int. Cl. G06Q 50/00; G06Q 50/30; G06F 9/451; H04L 29/08

(52) U.S. Cl. CPC G06Q 50/01; G06Q 50/30; G06Q 20/127; H04L 67/18; G06F 9/451

(57) ABSTRACT

Methods, systems, and computer program products for linking computing devices of drivers within a given range are provided. The methods and systems may determine, by one or more computing devices, a group of user/drivers within a given range of an initiating user/driver and generate, by the one or more computing devices, data representing the user/drivers within the given range. The methods and systems may present on a computing device of the initiating user/driver the data representing user/drivers within the given range in a manner that a user/driver from the group of user/drivers is selectable by the initiating user/driver and can determine, by the computing device operated by the initiating user/driver, a selected user/driver that was selected by the first user. Further, the methods and systems may electronically link a computing device operated by the selected user/driver to the computing device operated by the initiating user/driver in a manner that the selected user/driver and the initiating user/driver are aware of an electronic link between the computing devices.

### RELATED APPLICATIONS

The presently disclosed subject matter claims the benefit of U.S. Provisional Patent Application Ser. No. 63/066,063, filed Aug. 14, 2020, the disclosure of which is incorporated herein by reference in its entirety.

### TECHNICAL FIELD

The present subject matter relates to systems, methods, and computer program products for connecting drivers in transit that are within a close vicinity to each other. In particular, the present subject matter provides systems, methods and computer program products that allow drivers to choose to make contact and connection with other drivers within a given range to each other while the drivers are in transit to relieve driving anxiety or provide help in case of an emergency.

### BACKGROUND

It's common for driving to trigger panic and anxiety in people. Just the thought of having to drive can make some people extremely anxious. For others, specific conditions may be particularly anxiety inducing, such as when a route involves crossing bridges or passing through tunnels. Driving related anxiety may seem like a unique and socially isolating situation. Such anxieties are more common than the general public thinks and can occur at any time for a driver whether traveling long or short distances. In reality, many people across the U.S. and around the world experience some level of stress, tension, and discomfort when driving. While “driving anxiety” is not technically a diagnosable mental health disorder, the symptoms are real, powerful, and can get progressively worse if ignored.

Symptoms of driving anxiety can range from mild discomfort to extreme distress. Signs of driving anxiety can range from a subtle change in thinking when grabbing the keys, to a slow-building anxiety while driving on the freeway, to a full-blown panic attack at the mere thought of getting behind the wheel. If the anxiety is left unaddressed, it can have significant impacts on people's lives and their driving ability.

For example, a panic attack while driving may cause a traffic accident, while avoidance of driving can leave people homebound and isolated.

For some drivers with driving anxiety, driving to a familiar location is not a cause for concern, but if they need to travel to a new location with new direction, near or far, their anxiety increases immensely. It is not just the fear that something bad will happen, it is the fear that something bad will happen in an unfamiliar place, far from home, and no one will be there to help. Another fear that increases anxiety for many is being stuck in traffic. It is an irritant no one likes, but if you have a fear of panic attacks traffic can be a terrifying experience. Anxiety targets certain organs in the body. While some may experience racing heart and difficulty breathing, others may experience diarrhea, lightheadedness, or nausea. The mere thought of having these symptoms and being stuck in traffic, results in more anxiety and more avoidance. For some, driving anxiety can be triggered by other specific events such as driving in the rain, crossing a large bridge, or driving at night.

Anxious driving behavior has been broadly conceptualized as an increase, decrease, or general disorganization of behavior as a consequence of anxiety during the operation of a motor vehicle. Although reported fear among these individuals may not reach formal criteria for any specific diagnosis, the influence of subjective anxiety on overt driving behavior can result in negative consequences for both the driver and other motorists. Driving related anxiety triggers a negative impact on the individual's physical and mental health and well-being. In the short-term, anxiety makes driving more stressful and difficult and results in reduced performance behind the wheel as well as physical discomfort from muscle tension. Over the long-term, a person who continues to drive while anxious could endure the cumulative experience of muscle tension, restlessness, fatigue, changes in heart rate, worry, fear, and stress. Furthermore, the long-term stress could make someone stay home and refuse to drive at all. When avoidance becomes this extreme, it could lead to problems related to finances, housing, relationships, and employment. There are ways for an individual to cope with driving related anxiety. For example, a person can take steps to understand the root causes associated with your driving related anxiety that can help the person develop the appropriate coping skills to minimize symptoms. Talking to a therapist can help a person suffering from driving anxiety explore strategies that help minimize symptoms and implement behavioral interventions and seek support from friends and family to help remind the suffering person of coping skills, keep the suffering person on track and drive with them to reduce tension and stress. These options, however, are less helpful when a driver is alone and their driving anxiety begins to rise. Unfortunately, drivers cannot simply dial 911 when they are feeling anxious while they are driving. Calling friends and family can provide some level of comfort but knowing that they may be far away and unable to help immediately may cause more anxiety.

As such, a need exists for drivers who have driving anxiety to increase their opportunity to lower their anxiety while they are driving.

### SUMMARY

The present subject matter relates to systems, methods, and computer program products for connecting drivers in transit who are within a close vicinity to each other via computing devices within their vehicles or carried by the drivers. In particular, the present subject matter provides systems, methods and computer program products that allow drivers using their computing devices to choose to make contact and connection with other drivers within a given range through computing devices associated with those drivers while the drivers are in transit to relieve driving anxiety or provide help in case of an emergency.

The present subject matter also relates to computer program products for connecting drivers in transit who are within a given range to each other using computing devices. The subject matter described herein may be implemented in software, in combination with hardware and/or firmware. For example, the subject matter described herein may be implemented in software executed by a hardware-enabled processor. In one exemplary implementation, the subject matter described herein of connecting drivers in transit who are within a given range using computing devices associated with the drivers may be implemented using a non-transitory computer readable medium having stored thereon executable instructions that when executed by the processor of a computer control the processor to perform steps. Exemplary non-transitory computer readable media suitable for implementing the subject matter described herein include chip memory devices or disk memory devices accessible by a processor, programmable logic devices, and application specific integrated circuits. In addition, a computer readable medium that implements the subject matter described herein may be located on a single computing platform or may be distributed across plural computing platforms. Further, it should be noted that the systems and methods utilize and can comprise communication systems and devices and their components and functionality described herein. These communication systems and devices constitute special purpose devices that improve the technological field of providing communication connections for and/or mechanisms for permitting driver within close proximity to communicate with each other while driving.

While one or more objects of the presently disclosed subject matter having been stated hereinabove, and which is achieved in whole or in part by the presently disclosed subject matter, other objects will become evident as the description proceeds when taken in connection with the accompanying drawings as best described hereinbelow proceeds when taken in connection with the accompanying drawings as best described hereinbelow.

### BRIEF DESCRIPTION OF THE DRAWINGS

A full and enabling disclosure of the present subject matter including the best mode thereof to one of ordinary skill in the art is set forth more particularly in the remainder of the specification, including reference to the accompanying figures, in which:

FIG. 1 illustrates an example computing environment according to example embodiments of the systems and methods according to the present subject matter;

FIG. 2 illustrates a schematic illustration of an embodiment of a method and system in practice to connect user/drivers to relieve driving anxiety according to the present subject matter;

FIG. 3 illustrates an example embodiment of a flow chart of a portion of an embodiment of a software application according to the present subject matter;

FIG. 4 illustrates an example embodiment of a login interface of an embodiment of a software application according to the present subject matter;

FIGS. 4A and 4B illustrate example embodiments of payment related interfaces of an embodiment of a software application according to the present subject matter;

FIG. 5 illustrates an example embodiment of a home page interface of an embodiment of a software application according to the present subject matter;

FIG. 6 illustrates an example embodiment of the home page interface of the embodiment of a software application according to FIG. 5 with a tool bar interface open;

FIG. 7A illustrates an example embodiment of a settings interface of an embodiment of a software application according to the present subject matter;

FIGS. 7B-7C illustrate example embodiments of profile interfaces of an embodiment of a software application according to the present subject matter;

FIGS. 8 and 9 illustrate at least portions of example methods according to example embodiments of the present disclosure; and

FIGS. 10-14 illustrate example embodiments of graphical user interfaces (GUIs) at different points during the use of example embodiments of the systems, methods, and software applications according to the present subject matter.

Repeat use of reference characters in the present specification and drawings is intended to represent analogous features or elements of the present subject matter.

### DETAILED DESCRIPTION

Reference now will be made to the embodiments of the present subject matter, one or more examples of which are set forth below. Each example is provided by way of an explanation of the present subject matter, not as a limitation. In fact, it will be apparent to those skilled in the art that various modifications and variations can be made in the present subject matter without departing from the scope or spirit of the present subject matter. For instance, features illustrated or described as one embodiment can be used on another embodiment to yield still a further embodiment. It is to be understood by one of ordinary skill in the art that the present discussion is a description of exemplary embodiments only, and is not intended as limiting the broader aspects of the present subject matter, which broader aspects are embodied in exemplary constructions.

Although the terms first, second, right, left, front, back, top, bottom, etc. may be used herein to describe various features, elements, components, regions, layers and/or sections, these features, elements, components, regions, layers and/or sections should not be limited by these terms. These terms are only used to distinguish one feature, element, component, region, layer, or section from another feature, element, component, region, layer, or section. Thus, a first feature, element, component, region, layer, or section discussed below could be termed a second feature, element, component, region, layer, or section without departing from the teachings of the disclosure herein.

Embodiments of the subject matter of the disclosure are described herein with reference to schematic illustrations of embodiments that may be idealized. As such, variations from the shapes and/or positions of features, elements, or components within the illustrations as a result of, for example but not limited to, user preferences, manufacturing techniques and/or tolerances are expected. Shapes, sizes and/or positions of features, elements or components illustrated in the figures may also be magnified, minimized, exaggerated, shifted, or simplified to facilitate explanation of the subject matter disclosed herein. Thus, the features, elements or components illustrated in the figures are schematic in nature and their shapes and/or positions are not intended to illustrate the precise configuration of the subject matter and are not necessarily intended to limit the scope of the subject matter disclosed herein unless it specifically stated otherwise herein.

It is to be understood that the ranges and limits mentioned herein include all ranges located within the prescribed limits (i.e., subranges). For instance, a range from about 0.1 of a mile to about 5 miles also includes ranges from about one mile to about 4 miles, about 1,000 feet to about 3 miles, 1.2 miles to 2.8 miles, and about 0.9 miles to about 1.8 miles. Further, a limit of up to about 2 miles also includes a limit of up to about 0.5 miles, up to about 1 mile, and up to about 1.4 miles, as well as ranges within the limit, such as from about 0.1 of a mile to about 2 miles, and from about 1.1 miles to about 1.5 miles.

“Computing device(s),” as used herein means one or more desktop computers, laptop computers, set-top devices, tablet computers, mobile devices, mobile smart devices, smartphones, wearable devices, servers, interactive vehicle computers, and/or the like and includes, but is not limited to any mobile electronic device configured with imaging and/or computing capabilities. Such computing devices can include, but are not limited to, at least one of a mobile smartphone, a personal digital assistant (PDA), a computing tablet, a personal media player, vehicle computer with interactive capabilities, or any like mobile electronic device configured with imaging and/or computing capabilities. In some embodiments, the computing device may be provisioned with a hardware-based processor that is configured to execute software programs or applications.

“Software” or “Software application” as used herein means a computer program product for and used on a computer, which can include, but is not limited to a mobile computing device or a vehicle computing device with interactive capabilities, that can be in the form of a non-transitory computer readable media comprising computer executable instructions embodied in a computer readable medium that when executed by a processor of a computer can control of the computer such that the computer can perform specific steps.

“Given range,” as used herein means a distance from and/or an area around a computing device of an initiating user/driver within which the computing device of the initiating user/driver can search for computing devices of other user/drivers to determine available user/drivers so that the computing device of the initiating user/driver can form an electronic link with a computing device of an available user/driver to relieve anxiety felt by the initiating user/driver. The given range may be movable, in that it can move with the computing device of the initiating user/driver as that computing device moves. The given range can be changeable in the area it covers, can move with the computing device, and can be measured in feet, yards, meters, kilometers, or miles.

“initiating user/driver” as used herein means a user/driver who begins a search using a software application on a computing device as described herein to find another user/driver with whom to connect though a link between computing devices within a given range to relieve driving anxiety.

“Selected user/driver” as used herein means a user/driver who is selected by the initiating user/driver with whom the initiating user/driver would like to connect to relieve driving anxiety and who is within a given range.

The present subject matter relates to systems, methods, and computer program products for connecting, or linking, drivers while driving to relieve driving related anxiety. The computer program product can serve three purposes. First, it can allow a user to communicate with other drivers if the user is feeling anxious to provide a sense that the user is not alone. It can permit anxious drivers to follow one another or just provide the knowledge that someone is within close proximity to the user and acknowledges the user's presence. Just by having such a connection with a person who can be available to help or to talk and is on the same stretch of road as the user, the user's driving anxiety or any other feeling of panic can be lessened while the user is driving.

Second, the computer program product can be used to alert other user/drivers who are within close vicinity when a medical emergency occurs. If a user has a medical emergency while driving, they should dial 911. This computer program product can allow a user to alert other user/drivers that are within close proximity for help while waiting for first responders to arrive. The program will alert drivers who have the same computer program product on their computing devices (i.e., user/drivers) within a given range of the user that the user has a medical emergency and needs immediate help. Such notifications could be helpful if another user/driver around the user having the emergency can provide assistance to the user having the emergency until the first responders arrive.

Third, the computer program product can allow users to identify medical conditions to be stored within the program and allows the user to activate the software application on their computing device as a precaution to allow for easy access to a notification system for drivers in the vicinity having the same program on their portable computing devices, if the user's medical condition arises while driving, for immediate attention while waiting for first responders to arrive.

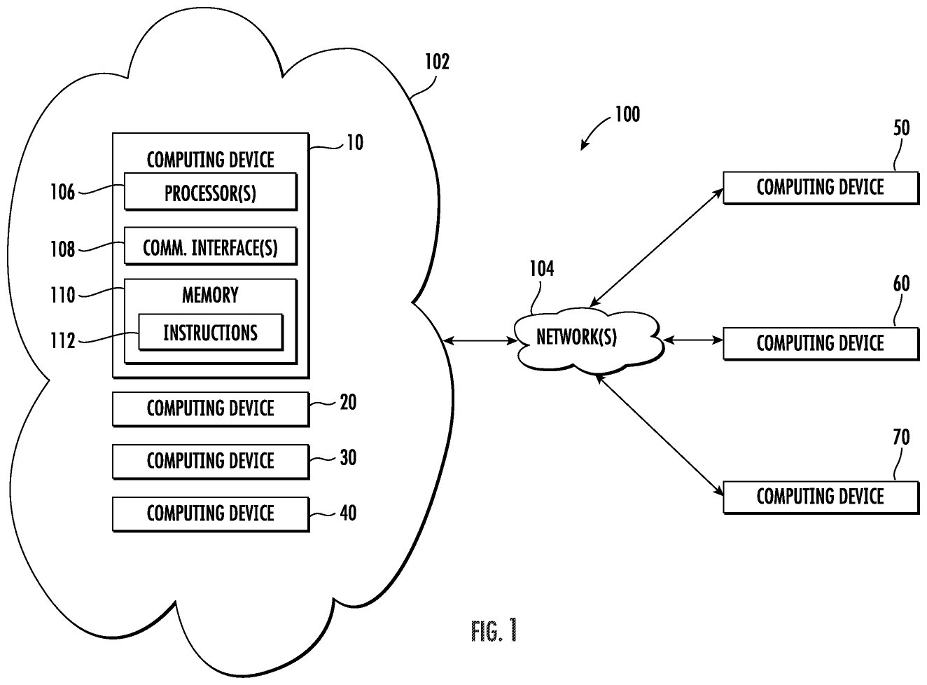

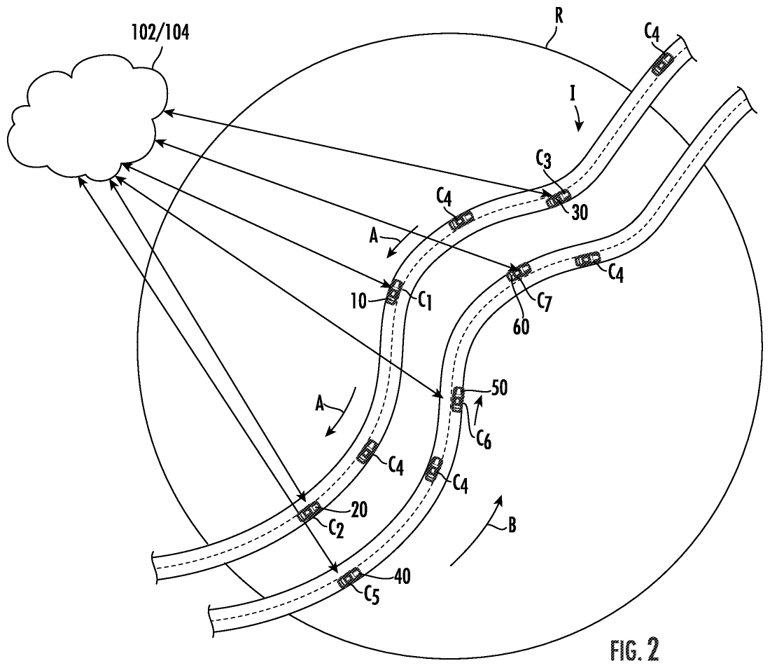

FIG. 1 depicts an example computing environment according to example embodiments of the present disclosure.

Referring to FIG. 1, environment 100 may include one or more computing devices (e.g., one or more desktop computers, laptop computers, set-top devices, tablet computers, mobile devices, smartphones, wearable devices, servers, interactive vehicle computers and/or the like). For example, environment 100 may include computing devices 10, 20, 30, 40, 50, 60, and/or 70, any one of which may include one or more associated and/or component computing devices (e.g., a mobile device and an associated wearable device, and/or the like). Environment 100 may also include one or more networks, for example, network(s) 102 and/or 104 (e.g., one or more wired networks, wireless networks, and/or the like). Network(s) 102 may interface computing device(s) 10, 20, 30, and/or 40, with one another and/or computing device(s) 50, 60, and/or 70 (e.g., via network(s) 104, and/or the like).

Computing device 10 may include one or more processor(s) 106, one or more communication interfaces 108, and memory 110 (e.g., one or more hardware components for storing executable instructions, data, and/or the like). Communication interface(s) 108 may enable computing device 10 to communicate with computing device(s) 20, 30, 40, 50, 60, and/or 70 (e.g., via network(s) 102, 104, and/or the like). Memory 110 may include (e.g., store, and/or the like) instructions 112. When executed by processor(s) 106, instructions 112 may cause computing device 10 to perform one or more operations, functions, and/or the like described herein. It will be appreciated that computing device(s) 20, 30, 40, 50, 60, and/or 70 may include one or more of the components described above with respect to computing device 10.

Unless explicitly indicated otherwise, the operations, functions, and/or the like described herein may be performed by computing device(s) 10, 20, 30, 40, 50, 60, and/or 70 (e.g., by computing device 10, 20, 30, 40, 50, 60, or 70, by any combination of one or more of computing device(s) 10, 20, 30, 40, 50, 60, and/or 70, and/or the like).

Referring to FIG. 2, in some embodiments of the methods and systems described herein, a first user/driver in a vehicle C₁, who may be using a computing device 10, which may be a smartphone or tablet, or a vehicle computer with which the user driver in vehicle C₁ can interact, may be driving along a road, such as an interstate, I in a first direction A. Other vehicles C₂, C₃ and C₄ may be traveling along in the same direction A. If the first user/driver in vehicle C₁ begins to feel anxiety about driving, the first user/driver can seek to make a connection with another user/driver nearby using his or her computing device 10. Using his or her computing device 10, the first user/driver can initiate a search for other user/drivers that have a software application as described herein on computing devices in their possession as they travel using the network(s) 102, 104. For example, once initiated, the computing device 10 can search for other computing devices with a given range R using the network(s) 102, 104. The computing device 10 can identified using the network(s) 102, 104 other user drivers, such as those in vehicles C₂, C₃, who have computing devices 20, 30 that have the software application thereon and are available for a connection. The drivers in vehicles C₄ may be drivers who are outside the given range R, drivers who do not have a computing device with the software thereon, or drivers who have changed a setting of the software on their computing devices to make them unavailable for a connection, i.e., are in dark mode. Once other user/drivers are identified, an electronic link can be made between the computing device 10 of the first user/driver, i.e., the initiating user/driver, and at least one of the other computing devices 20, 30 if a request for the link is accepted by the other user/driver to help alleviate the anxiety that the first user/driver may be feeling as explained in more detail below.

The given range R can be centered around the computing device of initiating user/driver. For example, the given range R can virtually extend outward from the computing device in the vehicle of the initiating user/driver in one or more range end distances. The range end distances can be between about 0.1 of a mile to about 5 miles. The computing device of the initiating user/driver can be at the center of the given range R. In some embodiments, the computing device of the initiating user/driver can be off center of the given range R, for example, to seek more available user/drivers behind the initiating user/driver. The range end distance can be, for example, a radius that extends, virtually, around the computing device of the initiating user/driver as determined by a global positioning system (GPS) and/or mapping program or system on the computing device of the initiating user/driver or in the software application. The range end distance that serves as a radius can also be between about 0.1 of a mile to about 5 miles. For example, in some embodiments, the given range R can be about a 2-mile radius from the computing device within the vehicle of a user/driver.

In some embodiments, the user/drivers in vehicles C₅, C₆, C₇ with computing devices 40, 50, 60 onboard that are traveling in direction B may not be identified as user/drivers available for a connection in a search performed by the computing device 10 since these vehicles C₅, C₆, C₇ are heading in a different direction. However, in a similar fashion, if the user/driver in vehicle C₆ is feeling anxious about driving and seeks a connection with other user/drivers traveling in the same direction B, the computing device 50 can identify using the network(s) 102, 104 other user drivers, such as those in vehicles C₅, C₇, who have computing devices 40, 60 that have the software application thereon, are within the given range of the computing device 50 and are available for a connection. Similarly, once other user/drivers are identified, an electronic link can be made between the computing device 50 and at least one of the other computing devices 40, 60 if a request for the link is accepted by the other user/driver to help relieve the anxious feelings the user/driver in vehicle C₆ may be experiencing.

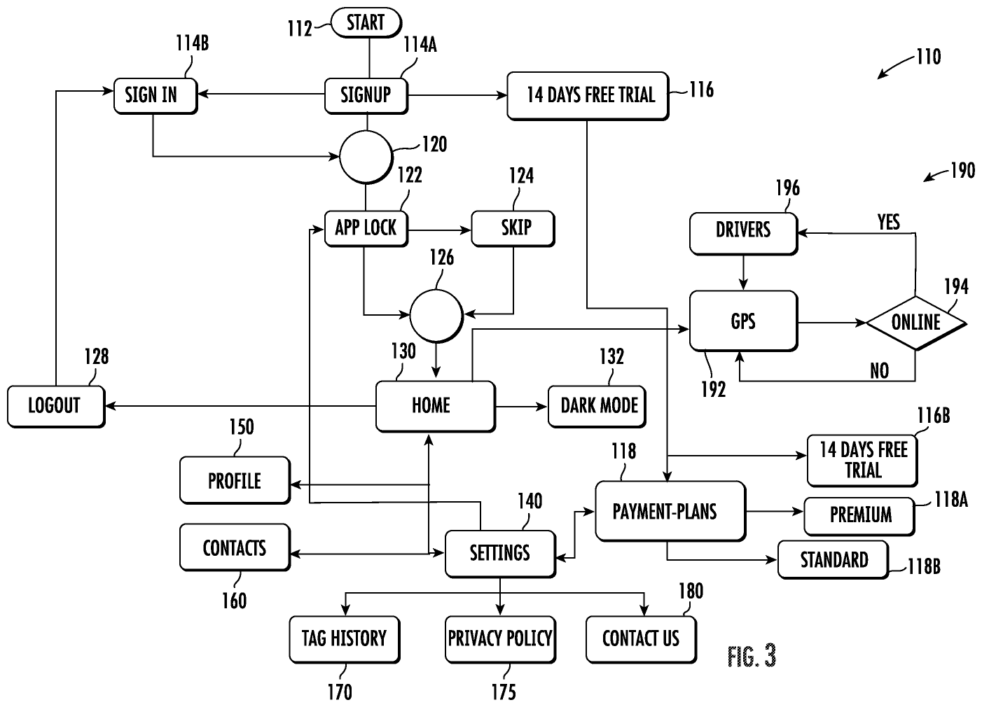

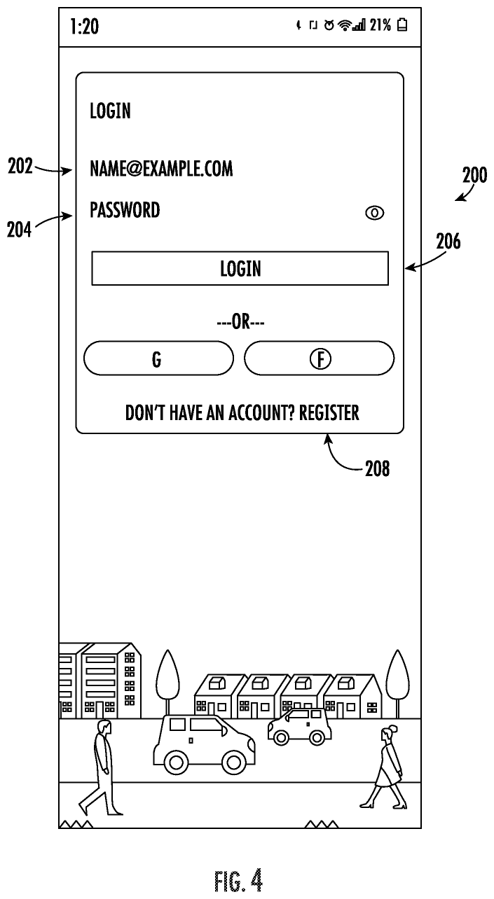

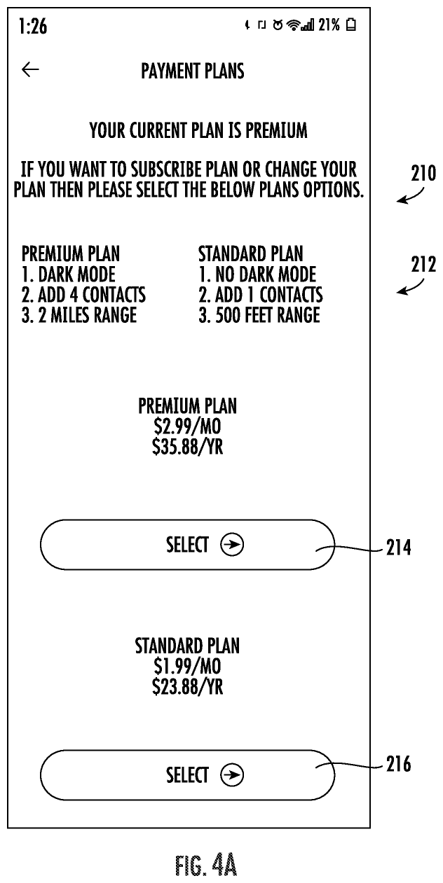

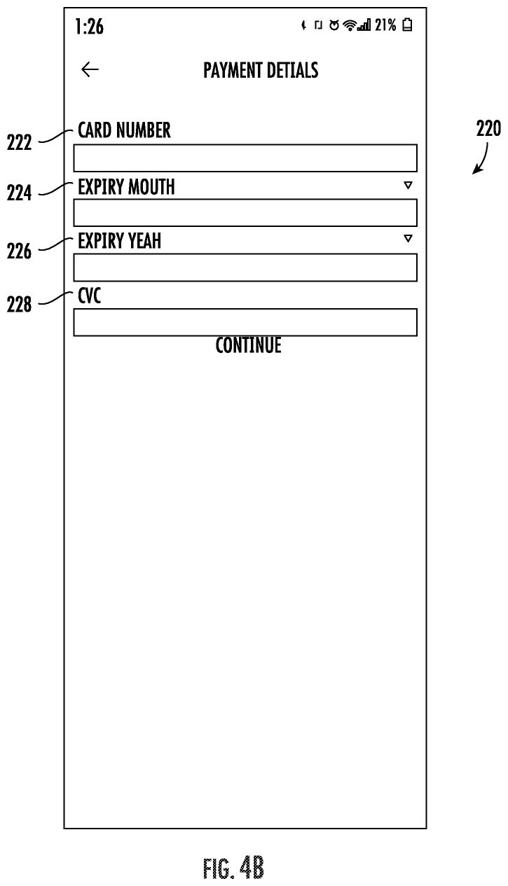

FIG. 3 shows an example embodiment of functional features of a software application 110 that can be used to make connections with drivers traveling the in the same direction within a given range to relieve driving anxiety felt by at least one of the drivers. The software application 110 can be started at 112 by clicking on an icon, for example, or through voice activation. The user can sign up at 112A if it is the user's first time using the software application 110, or if the user is already signed up, then the user can sign in at 114B. For example, the user can be taken to a login screen 200 as shown in FIG. 4 where the user can enter in a user identification at 202 and a password at 204 and tap on a graphical user interface (“GUI”) icon button 206 to login. If it is the first time that the user has used the software application 110, then the user can tap on the register link 208 to fill in the necessary information to sign up within the software application. Alternatively, in some embodiments, a user can login in using their Facebook® or social media accounts. For example, GUI icons can be provided for signing in using such social media accounts.

Referring back to FIG. 3, if it is the first time that a user is signing up, the user may be given a free trial, for example, a 14-day trial period, to at 116 and be taken to a page that explains the trial period at 116B. Additionally, the user may be taken to a payment plan page at 118 where the user can select, for example, a premium plan 118A or a standard plan 118B. For example, as shown in FIG. 4A, the user can be taken to a payment plan screen 210 that example the different available plans at 212 and their features and allow the user to select the different plan the user desires using GUI icon buttons 214 or 216. Once a payment plan is selected, the user can be taken to a payment details screen 220 shown in FIG. 4B, for example, where the user can enter their credit card information such as their credit card number at 222, the expiration date at 224 and 226 and the CVC number at 228.

Once signed in, the user can enter the software application at 120 and may be taken to a software application lock screen at 122 if it is set up, or it can be skipped at 124 if the software application lock is not set-up as shown in FIG. 3. Once past the software application lock, the user can be taken at 126 to a home screen 130.

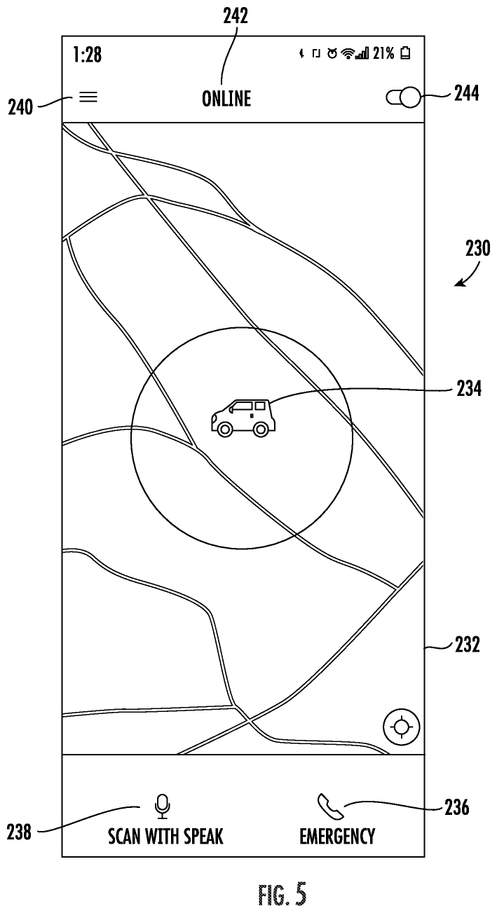

As shown in FIG. 5, in some embodiments for example, a home screen 230 can comprise a map 232 with a GUI icon of a vehicle 234 thereon that can represent the user and the user's current location. The home screen 230 can have an emergency GUI icon 236 that can provide a direct contact to emergency services, for example, through 911. Additionally, the home screen 230 can provide a GUI icon 238 for activating a voice control feature for hands free interaction with the software application. The home screen 230 can also include a tool feature icon 240 that lists the different features to manage the software application 110 when tapped. The home screen can also include a notification if the software application is online or offline at 242 and a GUI icon 244 that can switch the software application from showing that the computing device is available for making a link to a dark mode that makes the user unavailable to make a link with another user/driver.

Referring to FIG. 3, different features used to manage a user's account within the software application can be accessed. From the home screen 130, the user can access the dark mode feature at 132 to make the computing device unavailable to other computing devices within the software application. For example, if first user searches for available users to make a connection, a second user who has activated dark mode, will not be captured in the first user's search. From the home screen 130, the user can also access a profile screen at 150 which include information about the user some of which that may be shared and some of which that may be kept private, a “contacts” feature at 160 that can list contacts that are made within the software application 110. Additionally, the user can access a settings feature at 140 that can provide a tag history that can list the different connection made during past travels at 170. The settings feature can also provide access to the privacy policy at 175 for the software application 110 and access to the payment plans at 118 as well as to an administrator contact feature at 180 that allows the user to contact the administrator of the software application. Further, the home screen 130 can provide access to a logout at 128 to logout of the software application.

To generate the map 232 as shown in FIG. 5 on the home screen 230 and to identify other available user/drivers when requested, the software application 110 can access a global positioning system (GPS) 192 on the computing device on which it is loaded. The software application can confirm if the computing device is online at 194 and obtain the necessary GPS coordinates and access a mapping feature or program on the computing device. Further, when requested, the software application can search for available computing devices of other user/drivers within the given range at 196 to be displayed on the home screen 130, 230 as explained further below.

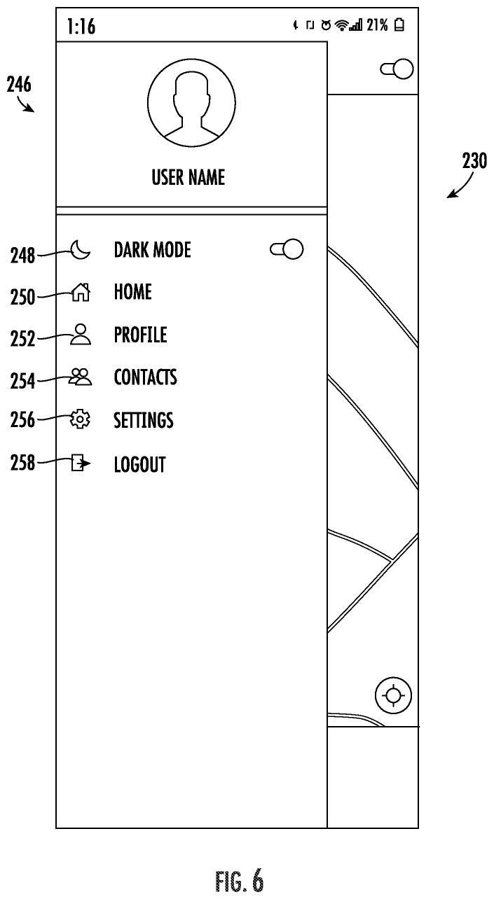

Referring to FIGS. 5 and 6, for example, if the tools feature icon 240 is tapped on the home screen 230, a tools window 246 can open that lists different features to help management a user's account within the software application. For example, the tools window 246 can provide access to the dark mode feature at 248, access back to the home screen at 250, access to the profile screen for editing at 252, access to the contacts screen that lists contact information for other user/drivers at 254, access to a settings screen at 256 and access to a logout screen at 258.

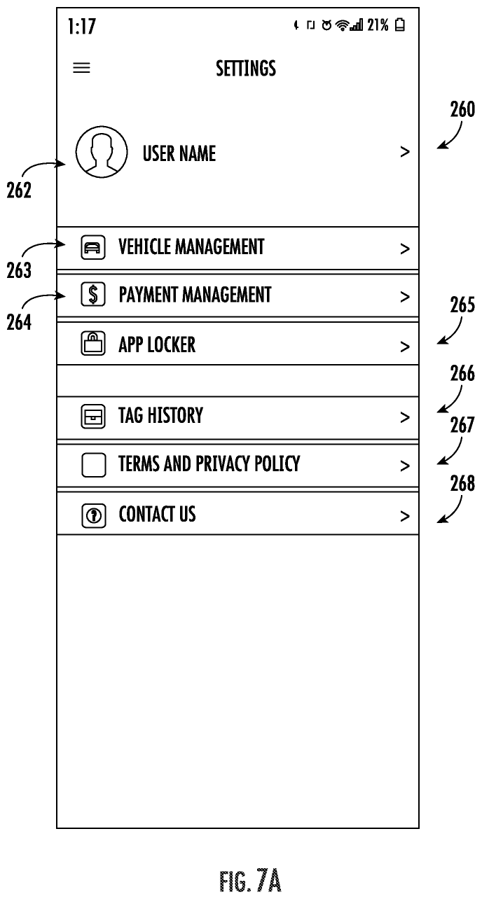

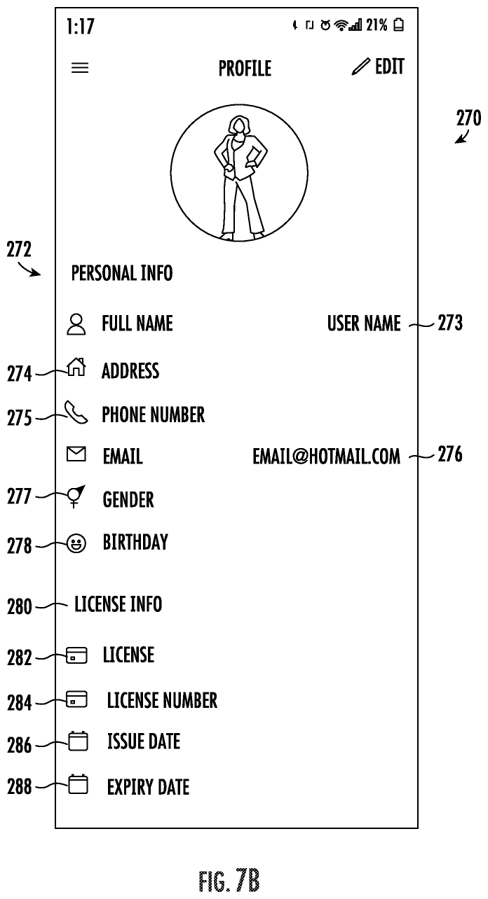

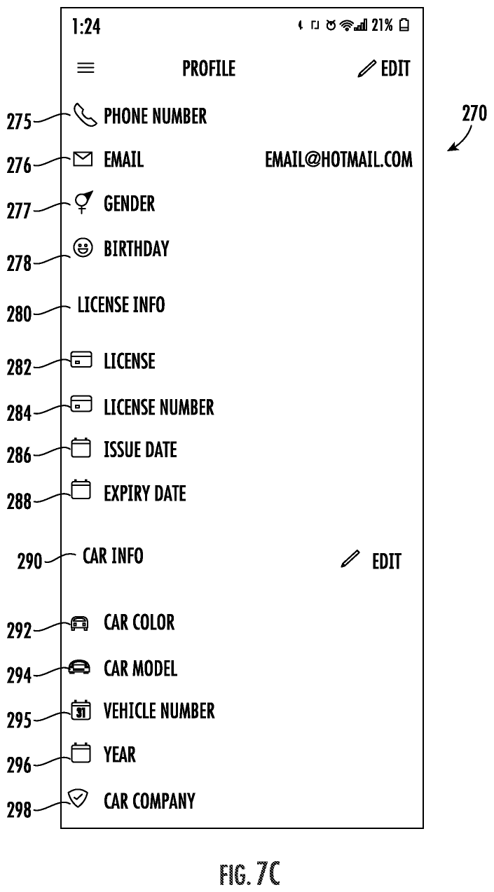

FIG. 7A shows a settings screen 260 that provides access to other screens that can be used to manage the user's use of the software application. In some embodiments, for example, the setting screen 260 can include a profile entry 262 that can be entered on a profile screen and include for example a username and profile image. The setting screen 260 can also include a tappable icon or link labeled “vehicle management” 263 that can take the user to the profile screen to enter or update their vehicle information as discussed below. Additionally, the setting screen 260 can include a tappable icon or link labeled “payment management” 264 that can take the user to the payment plan screen to enter or update their payment method information as previously discussed. Further, the setting screen 260 can include a tappable icon or link labeled “App Locker” 265 that can take the user to a screen to manage how, when, and if the software application locks requiring reentry of a username and/or password to regain access to the software application. The setting screen 260 can also include other tappable icons or links, including but not limited to, a Tag History icon 266 that takes the user to a listing of previous electronic links with computing devices of other user/drivers that have been created, a “Terms and Privacy Policy” icon 267 that takes the user to a one or more screens that include the terms and conditions and the privacy policy relating to use of the software application, and a “Contact Us” icon 268 that can take the user to a screen with contact information for the owner/administrator of the software application which can include, but is not limited to, telephone number(s), email address(es), Facebook® account(s) information, Instagram® account(s) information, or the like, for example.

As shown in FIGS. 7B and 7C, a profile screen 270 can be provided that can be accessed when signing up in the software application or can be accessed through the tools window 246 under the tools feature icon 240 to edit and revise the user's profile within the software application. Generally speaking, the profile information collected in the profile screen 270 can be kept private excepted for general information shared in a basic profile, such as username, which may be different from the user's actual name, and car make, color and model that is shared during the use of the software application to make connections between user/drivers within a given range to relieve anxiety of an initiating driver as explained below. The profile screen 270 can include input fields for personal information 272 including, but not necessarily limited to a name 273, a username (not shown), an address 274, one or more phone numbers 275, an email address 276, a gender 277, and a birthday 278. The profile screen 270 also can include input fields for license information 280 including, but not necessarily limited to the name of the state or municipality of issuance for the license 282, a license number 284, an issuance date 286, and an expiration date 288. Additionally, the profile screen 270 can include input fields for vehicle information 290 that may include, but not necessarily limited to, a vehicle color 292, a vehicle model 284, a vehicle number (or VIN number) 295, a model year 296, and a name of a company of manufacture (or make) 298.

The above descriptions of the screen and data collection for the software application have been provided as examples and should not be used to limit the scope of the present disclosure unless expressly stated.

Referring to FIGS. 1, 2, 8 and 9, example aspects of methods or processes that the software application can provide to aid a user/driver in lowering their anxiety while driving can be described. If a user/driver begins to become anxious or sick while driving, the user/driver can activate the software application on their mobile computing device that can assist the user/driver by allowing them to make a connection with another driver via an electronic link between that user/driver's computing device and the other user/driver's computing device. This electronic link provides a connection, hereinafter called a tag or tagging, that allows the initiating user/driver to feel secure that someone within a given vicinity or range set within the software application from the initiating user/driver is available to help if the anxiety rises to unacceptable levels. The initiating user/driver can know that someone is in close proximity and is traveling in the same direction to help and/or to talk with. This knowledge can provide comfort to the initiating user/driver thereby helping to lower their anxiety levels.

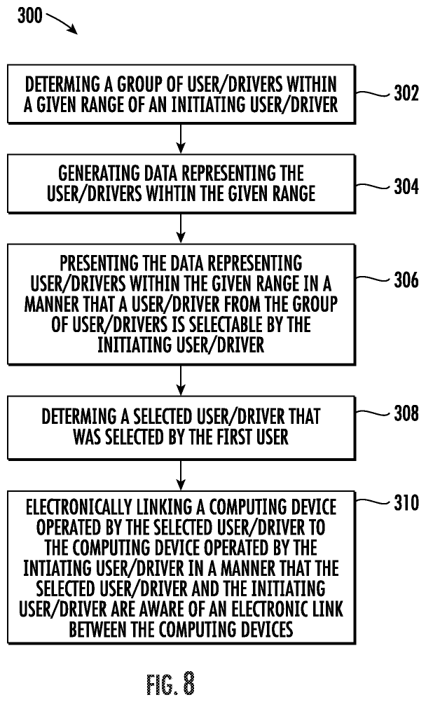

Referring to FIG. 8 and FIG. 2, once the software application has been activated in a process 300 for linking computing devices of drivers within a given range, the computing device of an initiating driver can begin by searching for another user/driver with whom to connect once the initiating user/driver initiates the search on their computing device. A determination of a group of user/drivers within a given range of an initiating user/driver can be made at 302. For example, computing device 10 using a GPS and its network communications therein can make an inquiry using the networks 102, 104, of all available computing devices, such as computing devices 20, 30 that have the software application downloaded, are available, and are within the given range as shown in FIG. 2.

Data representing the user/drivers within the given range can be generated at 304 based on the determination at 302 and then can be presented on the computing device of the initiating user/driver in a manner that a user/driver from the group of user/drivers is selectable by the initiating user/driver at 306 as shown in FIG. 8. This data can be presented on the computing device 10 of the initiating user/driver in this example. In some embodiments, the data representing the user/drivers within the given range can be represented by a graphical user interface (GUI) for presentation to the initiating user/driver on the computing device 10 of the initiating user/driver with the GUI indicating other user/drivers in the vehicles C₂, C₃ within the given range R. In particular, in some embodiments, GUI icons representing the user/drivers in the vehicles C₂, C₃ within the given range R can be presented on the computing device 10 which can be selectable by the initiating user/driver to present presented information about each user/driver represented by the corresponding GUI icon, such a basic user profile. Such presented information can be, for example, a username and the make, model, and color of the vehicle of the selected user/driver. In some embodiments, the data representing user/drivers within the given range can be presented as a voice description of the data representing user/drivers within the given range using a speaker on the computing device 10 of the initiating user/driver. Similarly, the determination of a selected user/driver that was selected by the initiating user/driver can be performed using a voice recognition feature on the computing device 10. For example, the computing device 10 can receive a voice command from the initiating user/driver using a microphone on the computing device 10.

Based on the selection by the initiating user/driver using their computing device 10, a determination by the computing device 10 of a selected user/driver that was selected by the first use can be made at 308. If both parties are agreeable, an electronically link between a computing device operated by the selected user/driver of and the computing device operated by the initiating user/driver can be made in a manner that the selected user/driver and the initiating user/driver are aware of an electronic link between the computing devices at 310. For example, in some embodiments, if the user/driver that operates computing deice 20 in FIG. 2 is selected, a tag request can be communicated from the computing device 10 to the computing device 20 for forming the electronic link between the computing device 10 and the computing device 20. The tag request can be presented on the computing device 20 in a manner that the selected user/driver has a choice to accept or decline the electronic linking of the computing device 10 operated by the initiating user/driver and the computing device 20 operated by the selected user/driver. The selected user/driver can accept or decline through at least one of GUI icons or voice recognition features on the computing device 20.

If the selected user declines the tag request, the computing device 20 operated by the selected user/driver, can communicate to the computing device 10 operated by the initiating user/driver that the request has been declined and the electronic link is ended. The computing device 10 can present to the initiating user that the request has be declined. Conversely, if the selected user/driver accepts the tag request, the computing device 20 can communicate to the computing device 10 operated by the initiating user/driver that the tag request is accepted, and the electronic link can continue. The computing device 10 can present to the initiating user/driver that the tag request has be accepted. The selected user/driver can accept or decline through at least one of GUI icons or voice recognition features.

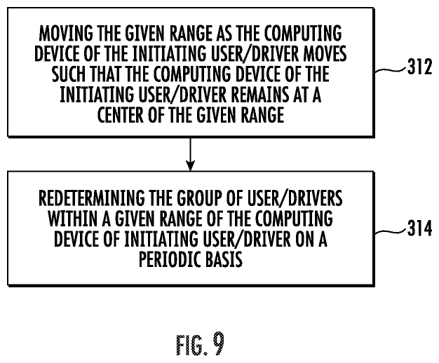

Referring to FIGS. 1, 2 and 9, other aspects of the methods or processes that the software application can be provided to aid a user/driver in lowering their anxiety while driving can include features related to the movability of the given range as the computing device of the initiating deriver moves with the initiating driver as the initiating user/driver travels can be added to the aspects shown in FIG. 8. In some embodiments, the given range can as the computing device of the initiating user/driver moves such that the computing device of the initiating user remains at a center of the given range at 312 as shown in FIG. 9. For example, referring to FIGS. 1 and 2, the computing device 10 can move the given range R as the initiating driver and their computing device 10 travel in the vehicle C₁ in a direction A, such that the computing device 10 of the initiating user remains at a center of the given range R.

Since the initiating user/driver and the other user drivers and their respective computing devices are all moving independent of each other as their vehicles travel, the group of user/drivers within the given range will change over time. For example, the vehicle C₁ with the initiating user driver and their computing device 10 therein may be traveling at a different rate of speed than the vehicle C₂ with a user driver and their computing device 20 therein. For instance, the vehicle C₂ may be traveling at a higher rate of speed than the vehicle C₁ causing the vehicle C₂ with the computing device 20 therein to leave the given range R centered around computing device 10 in the vehicle C₁. Similarly, as another example, the user/driver with the computing device 30 traveling in the vehicle C₃ may be traveling a different route than the user/driver with the computing device 10 traveling in the vehicle C₁. The user/driver with the computing device 30 traveling in the vehicle C₃ may turn onto another road at some point exiting the interstate I. Therefore, in some embodiments, it can be beneficial to reassess the group of available user/drivers within the given range as the different user/drivers travel along their respective routes. Thus, the methods herein can provide for a redetermination of the group of user/drivers within the given range of the computing device of the initiating user/driver on a periodic basis at 314.

The intervals at which the redetermination occurs can vary. In some embodiments, the interval can be varied by the user/driver using the software application or can be changed, modified, or varied by the software application owner/developer/administrator. For example, in some embodiments, this redetermination of available user/drivers can occur at intervals in a range of about 1 minute to about 5 minutes. For instance, in some embodiments, this redetermination of available user/drivers can occur about every minute, about every 2 minutes or about every 5 minutes. In some embodiments, this redetermination of available user/drivers can occur more frequently. For example, in some embodiments, this redetermination of available user/drivers can occur at intervals in a range of about 1 second to about 30 seconds. For instance, in some embodiments, this redetermination of available user/drivers can occur about every second, about every 5 seconds, about every 15 seconds, or about every 30 seconds. In some embodiments, the redetermination of available user/drivers can occur at faster speeds such that the redetermination can be considered continuous. As the redetermination occurs a refreshing of the presentation of the data representing the available user/drivers can also occur on the computing device of the initiating user driver. In some embodiments, once an electronic link between the computing device of the initiating user/driver and the computing device of the selected user/driver is made, the redetermination of available user/drivers can be paused or stopped. Once the electronic link is terminated, the aspects of the methods shown in FIGS. 8 and 9 can begin again, including the redetermination available user/drivers on a periodic basis. In some embodiments, once an electronic link between the computing device of the initiating user/driver and the computing device of the selected user/driver is made, the redetermination of available user/drivers, including the selected user/driver, can continue.

Once selected user/driver accepts the tag request, the electronic link between the initiating user/driver and the selected user/driver, who can now be considered the tagged user/driver, can permit both the initiating user/driver and the tagged user/driver to know of and find comfort in the connection between the two user/drivers. If something occurs to one of the two respective user/drivers, the user/drivers can directly communicate through at least one of texting or a phone call, for example, through a contact button or icon, using their respective computing devices. The electronic link between the initiating user/driver and the selected user/driver, who can now be considered the tagged user/driver, will continue until a termination of the electronic link between the computing devices of the initiating user/driver and selected user/driver occurs. Such a termination can occur for different reasons. For example, the electronic link can be terminated by one of the user/drivers that is participating ending the electronic link. Thus, the electronic link can be ended at the direction of the computing device of the initiating user/driver or the direction of the computing device of the selected user/driver. The electronic link can be ended by a powering down or an interruption or loss of service of the computer device of either the initiating user/driver or the selected user/driver. Similarly, the ending of electronic link between the computing devices can occur if the computing device of the selected user driver leaves the given range centered around the computing device of the initiating user/driver. Once the electronic link has ended between an initiating user/driver and a tagged user/driver, the initiating user driver can begin a new search for available user/drivers with whom to make a connection, if desired, and the methods herein can be repeated. Additionally, if the selected, or tagged, user/driver wishes to make another connection, then that user/driver can become an initiating user/driver by initiating their own search for available user/drivers with whom to make a connection using one or more of the methods described above.

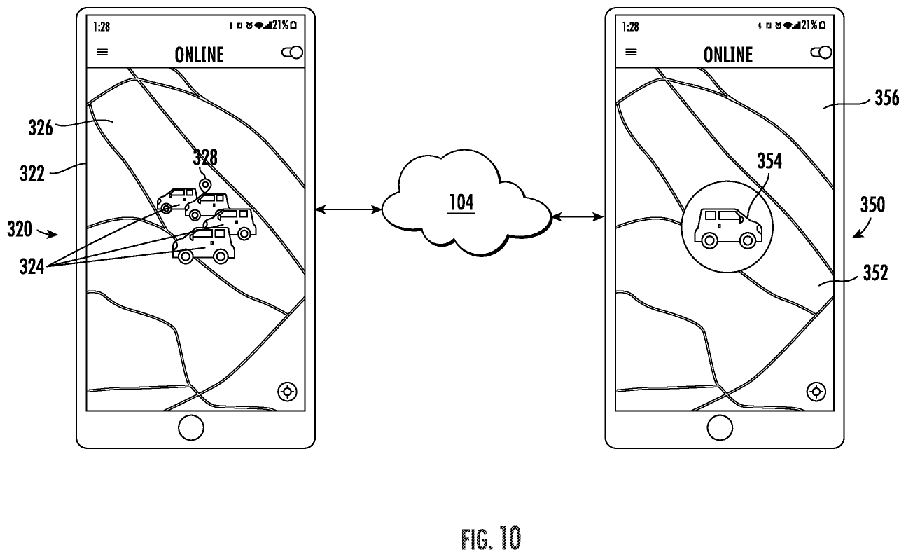

The features of the methods, systems and software applications are described in more detail with reference to FIGS. 10-14 which provides an example of two computing devices 320, 350 with the computing device 320 representing a computing device of an initiating user/driver and the computing device 350 representing a computing device of a selected user/driver. Each computing device 320, 350 can include a viewing screen 322, 352 that supports a graphical user interface. The software application described herein can be downloaded on the respective computing devices 320, 350.

The user/driver operating the computing device 320 can initiate the software application on computing device 320 before a journey begins, or anytime during the journey, and it can be running in the background on the computing device 320 waiting on a request from the user/driver. Similarly, the other user/driver who owns and operates the computing device 350 can initiate the software application on computing device 350 before a journey begins, or anytime during the journey, and it can be running in the background on the computing device 350 waiting on a request from that user/driver. Once the software application is initiated on the respective user/driver's computing devices 320, 350, a microphone device on the computing devices 320, 350 can be turned on to provide voice-activated, hands-free use of the software application, if desired. Using the microphone device and speaker system of the respective computing devices 320, 350, the interaction with the software application can be performed by voice control so that respective user/driver can operate the software application hands free. Additionally, or alternatively, the option can be provided for the user/driver to use the software application on the respective computing devices 320, 350 through a graphical user interface (“GUI”) and manually selecting tasks to be accomplished by the software application by tapping displays, such as buttons, displayed on the screen of the smart device or by entering text.

If the user/driver operating the computing device 320 begins to become anxious or sick while driving, the user/driver can initiate the software application on their computing device 320 to assist in making a connection with another driver via an electronic link between that the user/driver's computing device 320 and another user/driver's computing device, such as computing device 350 via a network 104. Thereby, the user driver operating the computing device 320 becomes the initiating user/driver. The computing device 320 can begin determining available user/drivers in a given range by seeking, via a network, other computing devices within the given range that have the software application thereon and are identified as available to enter an electronic link. The software can begin to periodically, or continuously, determine if there are other user/drivers within the given range set within the software application by seeking, via a network, the available computing devices within the given range. As stated above, the given range can vary and can be set by the user or be permanently set by the software application. The range distance can be from about 0.1 of a mile to about 5 miles. For example, the range distance can be a radius of about 0.1 of a mile in some embodiments. In some embodiments, the range distance can be a radius of about 2 miles.

Referring to FIG. 10, once the available user/drivers are determined, representations of the available user/drivers within the given range can be displayed on the screen 322 of the computing device 320 as GUI vehicle icons 324 on a map 326 that represents the road and/or the area in which the initiating driver's vehicle is traveling as shown in FIG. 10. The map 326 can be centered around the location of the computing device 320 and/or the center of the given range relative to the computing device 320. The map 326 can also track with the travel of the initiating user/driver, as is common with mapping applications on mobile computing devices. An icon 328 can also be presented on the screen 322 of the computing device 320 that represents the vehicle of the initiating user/driver in which the computing device 320 resides. In some embodiments, the positioning of the various GUI vehicle icons 324 relative to the icon 328 can generally represent the location of the various vehicles of the other available user/drivers and their general distance from the vehicle in which the computing device 320 resides. To periodically or continuously update the GUI icons representing the available user/drivers on the screen, the software application on the computing device 320 can access and use a GPS system, a mapping program or application, and/or other directional guidance systems on the computing device 320.

On the computing device 350 of the user/driver who did not initiate the search to make a link, the screen 352 can display an icon 354 that represents the vehicle of the user/driver in which the computing device 350 resides. The map 356 can represent the road and/or the area in which vehicle that has the computing device 350 of the user/driver therein is traveling. The map 356 can be centered around the location of the computing device 350. The map 356 can track and move with the travel of the user/driver operating computing device 350.

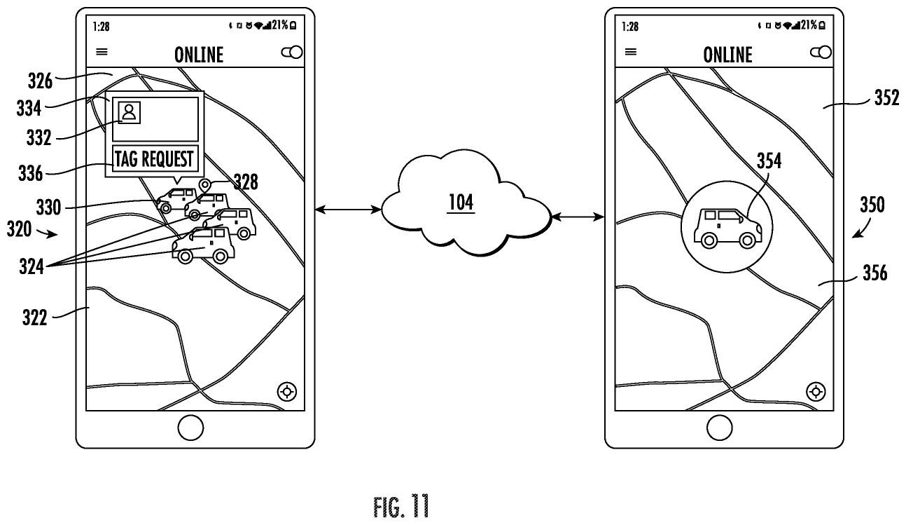

To tag an available user/driver within the given range, the initiating user/driver can view the screen 322 of the computing device 320 to see the GUI vehicle icons 324, 330 representing the other available user/drivers within the given range as shown in FIG. 11. The initiating user/driver can then select a user/driver from the available user/drivers shown. To select an available user/driver, the GUI display on the screen 322 of the computing device 320 of the initiating user/driver provide selectable the vehicle icons 324, 330 on the map 326 of the section of the road on which the user/driver is traveling. The criteria for selecting a user/driver can be dependent upon settings selected and set at the initiating user/driver's discretion or preset within the software application depending on the embodiment of the software application. The selected user/driver, for example, can be the user/driver who is closest to the initiating user/driver according to the given range on the software application that the initiating driver feels comfortable choosing.

In some embodiments, each vehicle icon 324, 330 can be tapped to reveal a user/driver display 332 on the screen 322 of the computing device 320 of the initiating user/driver of a basic user/driver profile of the user/driver whom the vehicle icon represents. As shown in FIG. 11, the vehicle icon 330, which represents the user/driver operating the computing device 350, has been selected for viewing and the user/driver display, or window, 332 provides the basic user/driver profile of the user/driver operating the computing device 350. The basic user profile may include a name, such as a username or a first name, possibly an image of the user/driver, and a general estimate of the distance between the vehicles. The basic user profile can operate as a GUI icon 334 within the user/driver window 332. The basic profile can be expanded to a fuller profile that can be displayed on the screen of the computing device 320 by tabbing on the basic profile GUI icon 334 if the initiating user/driver desires more information. Additionally, or alternatively, in some embodiments, the software application can provide an audio description to the initiating user/driver of the basic profile of the user/drivers within the given range to permit the initiating user/driver to select the user/driver using voice control.

In some embodiments, this fuller profile may only display car-related information above and beyond what the basic profile provides, such as the color, make and model of the vehicle of the available user/driver. This identifying information can provide more comfort to the initiating user/driver feeling high anxiety. At the same time, the user/driver window 332 and the fuller profile are only providing information that can be seen by the user/driver and not personal information. In most embodiments, this fuller profile does not display personal information such as, home address, last name, age, phone number, race and/or marital status.

Once an available user/driver is selected to be tagged, i.e., creating an electronic link between the computing device 320 and the computing device of the selected user/driver, the initiating user/driver can request a tag, or connection, with the selected user/driver using voice control or by tapping a request tag button displayed on the screen. For example, as shown in FIG. 11, after reviewing the basic user profile information in the user/driver window 332 associated with the vehicle icon 330, which represents the user/driver operating the computing device 350, the initiating user/driver can tap the GUI icon 336 that represents a tag button in the user/driver window 332 to initiate a tag request for the user/driver operating the computing device 350.

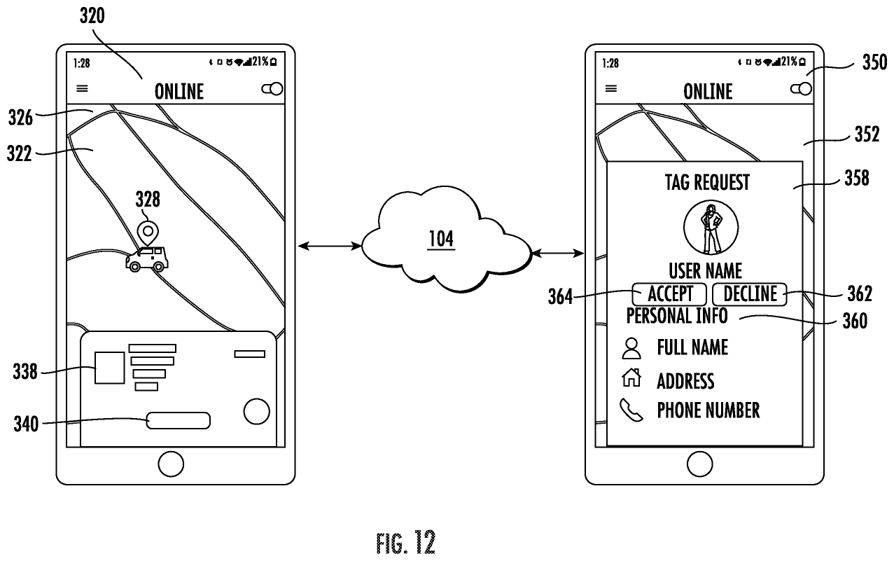

Referring to FIG. 12, once the tag is requested, the computing device 350 of the selected user/driver will receive a request notice via the network 104. A request notice window 358 can be displayed on the screen 352 of the computing device 350. The request notice window 358 can include basic profile information 360 of the initiating user/driver. The selected user/driver can either accept or deny the tag request. For example, the request notice window 358 on the screen 352 of the computing device 350 can include a GUI icon representing an Accept button 364 that the selected user/driver can tap to accept the tag request and a GUI icon representing a Decline button 362 that the selected user/driver can tap to decline the tag request. Additionally, or alternatively, the selected user/driver can receive an audio notification and can tell the software application to accept or decline the tag request using the voice control feature.

At the same time, in some embodiments, a “request sent” notice can be displayed on the initiating user/driver's computing device 320 and/or audio notification that the request has been sent can be provided to the initiating user/driver via the software application and the computing device 320. For example, while the tag request is pending on the computing device 350 of the selected user/driver, the screen 322 of the computing device 320 can show the icon 328 that represents the vehicle of the initiating user/driver in which the computing device 320 resides on the map 326 of the road and location on which the vehicle travels. The screen 322 of the computing device 320 can also display a pending request window 338 that can include the basic profile information of the selected user/driver and information showing that the tag request is pending. In the embodiment shown, the pending request window 338 can also include an emergency button GUI icon 340 that can be tapped by the initiating user/driver to directly connect the computing device 320 of the initiating user/driver with the emergency services, such as 911.

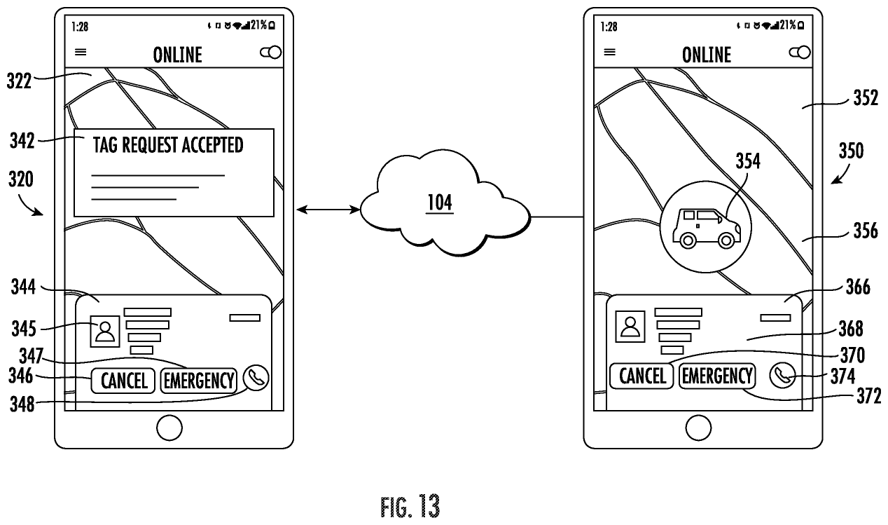

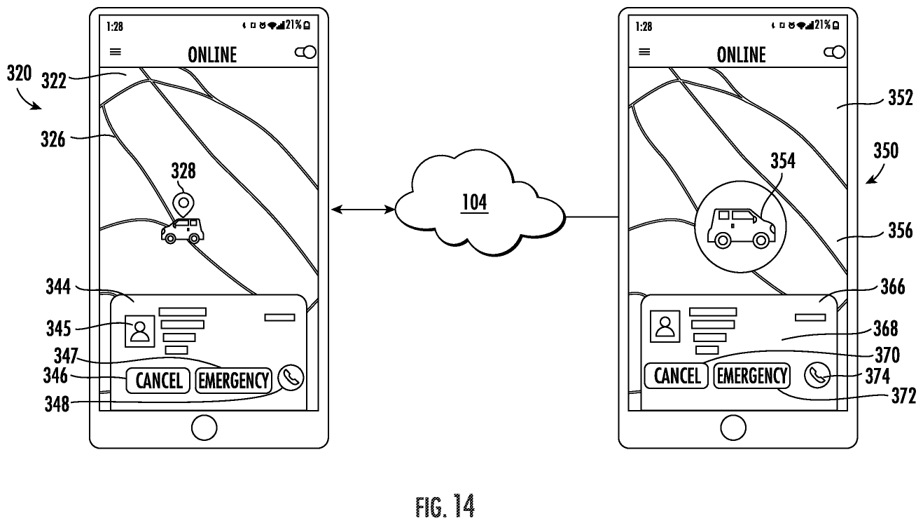

Referring to FIGS. 13 and 14, if the selected user/driver accepts the tag request, the selected, or tagged, user/driver and the initiating user/driver will share a connection through an electronic link between their respective computing devices 320, 350 until one party ends the electronic link by canceling the tag for whatever reason, the electronic link is lost due to service or other technical issues, or the user/drivers are out of range of each other. When the tag request is accepted by the selected user/driver, the screen 322 of the computing device 320 can briefly display acceptance notification window 342 informing the initiating user/driver that the tag request has been accepted as shown in FIG. 13. After the acceptance notification window 342 fades or terminates, the screen 322 of the computing device 320 can show the icon 328 that represents the vehicle of the initiating user/driver in which the computing device 320 resides on the map 326 of the road on which the vehicle travels and its location. In some embodiments, the screen 322 of the computing device 320 may also display a vehicle icon representing the general location of the vehicle of the tagged user/driver in which the computing device 350 resides relative to the vehicle of the initiating user/driver in which the computing device 320 resides and may also provide the distance between the vehicles. Once the electronic link between the computing device 320 and the computing device 350 is made, the location of the computing device 320 and the computing device 350 relative to each other is updated from time to time, for example, between about every 5 seconds and about every 2 minutes. For example, the location of the computing device 320 and the computing device 350 can be updated about every 30 seconds.

The screen 322 of the computing device 320 can then also display a tag information window 344 that stays on a portion of the screen 322 of the computing device 320 as shown in FIGS. 13 and 14 until the electronic link is terminated. The tag information window 344 can display the basic profile information icon 345 of the tagged user/driver that can be tapped to provide a fuller expanded profile of the tagged user/driver. The tag information window 344 may also display the distance between the vehicles. The distance can be expressed in feet, meters, miles, or kilometers. The tag information window 344 can also include multiple GUI icons 346, 347, 348 that can provide access to different services and functions to the initiating driver.

The tag information window 344 can include a “cancel” button icon 346 that can be tapped by the initiating user/driver to cancel or end the electronic link or tag. Additionally, or alternatively, the initiating user/driver can use the voice control feature of the software application to cancel the tag and disconnect the smart devices. In some embodiments, tag information window 344 can include an emergency call button icon 347 that can be used to notify EMS, or other first responders through the 911 system by automatically calling 911 when tapped. Alternatively, the initiating user/drivers can use the voice control feature of the software application to contact the 911 system. Further, while the user/drivers do not have to directly communicate, a contact button icon 348 can be provided in the tag information window 344 that can provide an option to contact the tagged user driver through computing device 350. For example, in some embodiments, the contact button icon 348 can be tapped to display the options of texting the tagged user/driver or calling the tagged user driver by tapping a respective button in a new contact window that is displayed on the screen 322 of the computing device 320. The tagged user/driver being contacted is not obligated in any way to respond or take the call from the initiating user/driver. If either user/driver begins to feel unsure about the connection or unsafe, then the electronic link, or tag, can be dropped by that party.

Similarly, when the tag request is accepted by the selected user/driver, the screen 352 of the computing device 350 can show the icon 356 that represents the vehicle of the tagged user/driver in which the computing device 350 resides on the map 356 of the road on which the vehicle travels and its location. Similar to the computing device 320 of the initiating user/driver, in some embodiments, the screen 352 of the computing device 350 may also display a vehicle icon representing the general location of the vehicle of the initiating user/driver in which the computing device 320 resides relative to the vehicle of the tagged user/driver in which the computing device 350 resides.

The screen 352 of the computing device 350 can then also display a tag information window 366 that stays on a portion of the screen 352 of the computing device 350 as shown in FIGS. 13 and 14 until the electronic link is terminated. The tag information window 366 can display the basic profile information icon 368 of the initiating user/driver that can be tapped to provide a fuller expanded profile of the initiating user/driver. The tag information window 366 may also display the distance between the vehicles. The distance can be expressed in feet, meters, miles, or kilometers. The tag information window 366 can also include multiple GUI icons 370, 372, 374 that can provide the tagged driver access to different services and functions as described further below.

The tag information window 366 can include a “cancel” button icon 370 that can be tapped by the tagged user/driver to cancel or end the electronic link or tag. Additionally, or alternatively, the initiating user/driver can use the voice control feature of the software application to cancel the tag and disconnect the computing devices. In some embodiments, tag information window 366 can include an emergency call button icon 372 that can be used to notify EMS, or other first responders through the 911 system by automatically calling 911 when tapped. Alternatively, the tagged user/driver can use the voice control feature of the software application to contact the 911 system. Further, a contact button icon 374 can be provided in the tag information window 366 that can provide an option to contact the initiating user/driver through computing device 320. For example, in some embodiments, the contact button icon 374 can be tapped to directly call the initiating user/driver. Alternatively, the contact button icon 374 can be tapped to display the options of texting the initiating user/driver or calling the initiating user driver by tapping a respective button in a new contact window (not shown) that is displayed on the screen 322 of the computing device 320. The initiating user/driver being contacted is not obligated in any way to respond or take the call from the tagged user/driver.

As stated above, the “cancel” button icons 346, 370 on the screens 322, 352 of the respective computing devices 320, 350 can be pushed at any time during the connection between the initiating user/driver and the tagged user/driver. If the cancel button icon 346, 370 is pushed by either user/driver, a second cancel confirmation window (not shown) is opened with a request to confirm cancellation. If the user/driver taps yes, then the electronic link between the computing device 320 and the computing device 350, i.e., the tag, is ended.

If the electronic link between the computing device 320 and the computing device 350 is dropped because the tagged user/driver moves out of the given range due to different driving speeds or a divergent course of travel, the software application can automatically search for another available user/driver within the given range. In some embodiments, the software application has the ability to create a tag history briefly discussed above that can be referenced by the user/driver to view the tags of which they have been a part. In some embodiments, the software application can also have a contact list of other user/drivers that are preferred connections if those user/drivers are in the given range as discussed above. For example, if a first user/driver goes to work a certain way every day and notices a recurring request for a tag from the same second user/driver and the first user/driver feels safe about the connection with that requesting second user/driver, then that second user/driver could be added to the contact list of the first user/driver if they chose to. Similarly, the second user/driver can add the first user/driver to their contact list.

Additionally, the software application can store in a memory on the respective computing device information about past requests, acceptances, declines, and connections relating to different user/drivers. If a tag request is ever declined, the software application can be configured so that any subsequent tag request between the respective user/drivers is also declined and not connection will be made, even if requested by either party. Also, if a first user/driver does not want a second user/driver to know they are in the area, then the dark mode feature can be used, and the software will not show that the first user/driver or their vehicle is within the given range when seeking the connection even if the first user/driver is within the range. In some embodiments, the software application can have a panic button. Additionally, or alternatively, in some embodiments, the software application can be configured to have trigger word, such as the term “panic” to initiate the dialing of 911 for assistance from law enforcement or medical emergency. IN some embodiments, pre-recorded calming exercises, such as breathing exercises or focus exercises can be provided for the user/driver to access when feeling anxious.

All user/drivers are required to upload current registration and photo for every vehicle that the user/driver will be using in conjunction with the software application. This information will be kept private and will not be displayed on another user/driver's computing device and the information will not be sold, rented, or distributed to anyone.

These and other modifications and variations to the present subject matter may be practiced by those of ordinary skill in the art, without departing from the spirit and scope of the present subject matter, which is more particularly set forth herein above and any appending claims. In addition, it should be understood the aspects of the various embodiments may be interchanged either in whole or in part. Furthermore, those of ordinary skill in the art will appreciate that the foregoing description is by way of example only, and is not intended to limit the present subject matter.

What is claimed is:

1. A method for linking computing devices of drivers within a given range, the method comprising:
determining, by one or more computing devices, a group of user/drivers within a given range of an initiating user/driver;
generating, by the one or more computing devices, data representing the user/drivers within the given range;
presenting, by a computing device operated by the initiating user/driver of the one or more computing devices, on the computing device of the initiating user/driver the data representing user/drivers within the given range in a manner that a user/driver from the group of user/drivers is selectable by the initiating user/driver;
determining, by the computing device operated by the initiating user/driver of the one or more computing devices, a selected user/driver that was selected by the first user; and
electronically linking, by the one or more computing devices, a computing device operated by the selected user/driver of the one or more computing devices to the computing device operated by the initiating user/driver of the one or more computing devices in a manner that the selected user/driver and the initiating user/driver are aware of an electronic link between the computing devices.

2. The method according to claim 1, further comprising:
communicating a tag request for forming the electronic link between the computing device operated by the initiating user/driver and the computing device operated by the selected user/driver from the computing device operated by the initiating user/driver to the computing device operated by the selected user/driver; and
presenting, by the computing device operated by the selected user/driver of the one or more computing devices, on the computing device of the selected user/driver a tag request by the initiating user/driver in a manner that the selected user/driver has a choice to accept or decline the electronic linking of the computing device operated by the initiating user/driver and the computing device operated by the selected user/driver.

3. The method according to claim 2, further comprising, upon the computing device operated by the selected user/driver receiving notification that the selected user/driver declines the request, communicating by the computing device operated by the selected user/driver to the computing device operated by the initiating user/driver that the request is declined and ending the electronic link; and
presenting, by the computing device operated by the initiating user/driver, on the computing device of the initiating user/driver that the request has be declined.

4. The method according to claim 2, wherein, upon the computing device operated by the selected user/driver receiving notification that the selected user/driver accepts the request, communicating by the computing device operated by the selected user/driver to the computing device operated by the initiating user/driver that the tag request is accepted and continuing the electronic link; and
presenting, by the computing device operated by the initiating user/driver, on the computing device of the initiating user/driver that the tag request has be accepted.

5. The method according to claim 1, wherein the presenting on the computing device of the initiating user/driver the data representing user/drivers within the given range comprises:
generating, by the one or more computing devices, data representing a graphical user interface (GUI) for presentation to the initiating user/driver on the computing device of the initiating user/driver, the GUI indicating other user/drivers within the given range, wherein:
GUI icons representing the user/drivers within the given range are selectable by the initiating user/driver to present presented information about each user/driver represented by the corresponding GUI icon; and
the presented information of a user/driver within the given range including a GUI icon that is selectable by the initiating user/driver to select the user/driver to request a tag.

6. The method according to claim 1, wherein the presenting on the computing device of the initiating user/driver the data representing user/drivers within the given range comprises generating a voice description of the data representing user/drivers within the given range using a speaker on the computing device of the initiating user/driver.

7. The method according to claim 6, wherein the determining a selected user/driver that was selected by the initiating user/driver comprises recognizing a voice command received by the computing device of the initiating user/driver using a microphone on the computing device of the initiating user/driver.

8. The method according to claim 1, wherein the given range is movable as the computing device of the initiating user/driver moves such that the computing device of the initiating user/driver remains at a center of the given range.

9. The method according to claim 8, further comprising redetermining, by one or more computing devices, the group of user/drivers within the given range of the computing device operated by the initiating user/driver on a periodic basis.

10. The method according to claim 1, further comprising terminating the electronic link between the computing devices of the initiating user/driver and selected user/driver upon one of the following occurring:
ending the electronic link at the direction of the computing device of the initiating user/driver or at the direction of the computing device of the selected user/driver;
powering down of the computer device of either the initiating user/driver or the selected user/driver; or
leaving of the computing device of the selected user driver from the given range.

11. A system comprising:
one or more processors; and
a memory storing instructions that when executed by the one or more processors cause the system to perform operations comprising:
determining a group of user/drivers within a given range of an initiating user/driver;
generating data representing the user/drivers within the given range;
presenting, by a computing device operated by an initiating user/driver, on the computing device of the initiating user/driver the data representing user/drivers within the given range in a manner that a user/driver from the group of user/drivers is selectable by the initiating user/driver;
determining a selected user/driver that was selected by the initiating user/driver; and
electronically linking a computing device operated by the selected user/driver of the one or more computing devices to the computing device operated by the initiating user/driver of the one or more computing devices in a manner that the selected user/driver and the initiating user/driver are aware of an electronic link between the computing devices.

12. The system of claim 11, wherein the operations further comprise:
communicating a tag request to the selected user/driver for forming the electronic link between the computing device operated by the initiating user/driver and the computing device operated by the selected user/driver from the computing device operated by the initiating user/driver to the computing device operated by the selected user/driver; and
presenting on the computing device of the selected user/driver a tag request by the initiating user/driver in a manner that the selected user/driver has a choice to accept or decline the electronic linking of the computing device operated by the initiating user/driver and the computing device operated by the selected user/driver.

13. The system of claim 12, wherein the operations further comprise, upon the computing device operated by the selected user/driver receiving notification that the selected user/driver declines the request, communicating by the computing device operated by the selected user/driver to the computing device operated by the initiating user/driver that the request is declined and ending the electronic link; and
presenting on the computing device of the initiating user/driver that the request has be declined.

14. The system of claim 12, wherein the operations further comprise, upon the computing device operated by the selected user/driver receiving notification that the selected user/driver accepts the request, communicating by the computing device operated by the selected user/driver to the computing device operated by the initiating user/driver that the tag request is accepted and continuing the electronic link; and
presenting on the computing device of the initiating user/driver that the tag request has be accepted.

15. The system of claim 11, wherein the operations further comprise, moving the given range as the computing device of the initiating user/driver moves such that the computing device of the initiating user remains at a center of the given range.

16. The system of claim 15, wherein the operations further comprise redetermining the group of user/drivers within a given range of the initiating user/driver on a periodic basis.

17. One or more non-transitory computer-readable media comprising instructions that when executed by one or more computing devices cause the one or more computing devices to perform operations comprising:
determining a group of user/drivers within a given range of an initiating user/driver;
generating data representing the user/drivers within the given range;
presenting, by a computing device operated by the initiating user/driver, on the computing device of the initiating user/driver the data representing user/drivers within the given range in a manner that a user/driver from the group of user/drivers is selectable by the initiating user/driver;
determining, by the computing device operated by the initiating user/driver, a selected user/driver that was selected by the initiating user/driver; and
electronically linking a computing device operated by the selected user/driver of the one or more computing devices to the computing device operated by the initiating user/driver of the one or more computing devices in a manner that the selected user/driver and the initiating user/driver are aware of an electronic link between the computing devices.

18. The one or more non-transitory computer-readable media of claim 17, wherein the operations of the presenting on the computing device of the initiating user/driver the data representing user/drivers within the given range comprises:
generating data representing a graphical user interface (GUI) for presentation to an initiating user/driver on the computing device of the initiating user/driver, the GUI indicating the other user/drivers within the given range, wherein:
GUI icons representing the user/drivers within the given range are selectable by the initiating user/driver to present presented information about each user/driver represented by the corresponding GUI icon; and
the presented information of a user/driver within the given range including a GUI icon that is selectable by the initiating user/driver to select the user/driver to request a tag.

19. The one or more non-transitory computer-readable media of claim 17, wherein the operations comprise moving the given range as the computing device of the initiating user/driver moves such that the computing device of the initiating user remains at a center of the given range.

20. The one or more non-transitory computer-readable media of claim 19, wherein the operations comprise redetermining the group of user/drivers within a given range of the initiating user/driver on a periodic basis.
